(19) United States
(12) Patent Application Publication
(10) Pub. No.: US 2026/0135137 A1
(43) Pub. Date: May 14, 2026

(54) CATHODE ACTIVE MATERIAL FOR LITHIUM-ION SECONDARY BATTERY

(71) Applicant: TOYOTA JIDOSHA KABUSHIKI KAISHA, Toyota-shi (JP)

(72) Inventors: Ryosuke Ohsawa, Okazaki-shi (JP); Taku Kinoshita, Toyota-shi (JP); Yuji Mahara, Toyota-shi (JP)

(73) Assignee: TOYOTA JIDOSHA KABUSHIKI KAISHA, Toyota-shi (JP)

(21) Appl. No.: 19/345,707

(22) Filed: Sep. 30, 2025

(30) Foreign Application Priority Data
Nov. 13, 2024 (JP) 2024-198139

(51) Int. Cl. H01M 10/0525; H01M 4/02; H01M 4/505; H01M 4/525

(52) U.S. Cl. CPC H01M 10/0525; H01M 4/505; H01M 4/525; H01M 2004/021; H01M 2004/028

(57) ABSTRACT

A cathode active material for a lithium ion secondary battery contains single-crystal particles. A crack group is created in a cross-section of the single-crystal particle. The crack group includes two or more of the cracks. The crack group includes a portion at which two or more cracks extend in parallel. The cathode active material satisfies a relation of “3%≤L/D”. “L” indicates a length of the crack. “D” indicates a diameter of a smallest circumscribing circle of the single-crystal particle in the cross-section.

### CROSS-REFERENCE TO RELATED APPLICATION

This application claims priority to Japanese Patent Application No. 2024-198139 filed on Nov. 13, 2024. The disclosure of the above-identified application, including the specification, drawings, and claims, is incorporated by reference herein in its entirety.

### BACKGROUND

### 1. Technical Field

The present disclosure relates to a cathode active material for a lithium-ion secondary battery.

### 2. Description of Related Art

Japanese Unexamined Patent Application Publication No. 2023-036570 (JP 2023-036570 A) discloses a large grain aggregate ternary cathode material with single-crystal-like morphology.

### SUMMARY

Single crystallization of cathode active material has been proposed. Single crystallization is expected to improve storage characteristics, for example. This is thought to be due to single-crystal particles having a smaller specific surface area as compared to polycrystalline particles. However, there is room for improvement regarding initial resistance of single-crystal particles.

An object of the present disclosure is to reduce initial resistance.
1. A cathode active material for a lithium-ion secondary battery contains a single-crystal particle. A crack group is created in a cross-section of the single-crystal particle. The crack group includes two or more cracks. The crack group includes a portion in which two or more of the cracks extend in parallel. The cathode active material satisfies a relation of “3%≤L/D”. “L” indicates a length of the cracks. “D” indicates a diameter of a smallest circumscribing circle of the single-crystal particle in the cross-section.

Formation of the crack group in the single-crystal particle is expected to reduce initial resistance. It is though that a diffusion path for ions is formed within the single-crystal particle due to electrolytic solution permeating into the single-crystal particle through the crack group. Hereinafter, the number of cracks will also be referred to as “crack count”. The length of the cracks is also referred to as “crack length”. The cathode active material for a lithium ion secondary battery may be abbreviated to “cathode active material”. The lithium ion secondary battery may be abbreviated to “battery”.
2. The cathode active material according to “1” above may include, for example, the following configuration. The crack group includes four or more to eight or less of the cracks.

The single-crystal particles repeatedly expand and contract due to repeated charging/discharging. Stress concentration can occur due to volume changes in the single-crystal particles. There is a possibility that cracking of the single-crystal particles due to stress concentration will promote capacity degradation. By forming four or more cracks in the single-crystal particles in advance, before performing charging and discharging in the battery, improvement in cycle characteristics can also be expected, for example, in addition to reduction of the initial resistance. It is thought that this is because the cracks mitigate stress concentration.
3. The cathode active material according to “1” or “2” above may include, for example, the following configuration. The cathode active material satisfies a relation of “6%≤L/D≤52%”.

When the relation of “6%≤L/D≤52%” is satisfied, improvement in cycle characteristics can also be expected, in addition to reduction of the initial resistance.
4. The cathode active material according to any one of “1” to “3” above may include, for example, the following configuration. The cathode active material is made up of the single-crystal particles that account for 50% or more in proportion of count, and polycrystalline particles that are a remainder.

The cathode active material may contain the polycrystalline particles in addition to the single-crystal particles. Due to the proportion of count of the single-crystal particles being 50% or more, improvement in cycle characteristics can be expected, for example.
5. The cathode active material according to any one of “1” to “4” above may include, for example, the following configuration. A composition of the cathode active material is expressed by a general formula: “LiₓNiₐCo_{b}Mn_{c}O_{y}”. In the general formula, “x, a, b, c, and y” satisfy relations of “0.1≤x≤1.5”, “0.5≤a≤1.0”, “0≤b≤0.3”, “0≤c≤0.3”, “a+b+c=1.0”, and also “1.5≤y≤2.1”.

Due to the Ni composition ratio “a” being 0.5 or more, for example, increase in initial discharge capacity is expected.

An embodiment of the present disclosure (hereinafter may be abbreviated to “present embodiment”) and an example of the present disclosure (hereinafter may be abbreviated to “present example”) will be described. It should be noted, however, that the present embodiment and the present example do not limit the technical scope of the present disclosure. The present embodiment and the present example are exemplary in all respects. The present embodiment and the present example are not limiting. The technical scope of the present disclosure encompasses all changes within the meaning and scope equivalent to the description of the claims. For example, it is anticipated from the beginning that any configurations may be extracted from the present embodiment and arbitrarily combined.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view of a single-crystal particle in an embodiment;

FIG. 2 is a table showing results of experimentation;

FIG. 3 is a first temperature profile; and

FIG. 4 is a second temperature profile.

### DETAILED DESCRIPTION OF EMBODIMENTS

### Terms and Phrases

“Comprise”, “include”, “have”, and variations thereof are open ended expressions. A configuration expressed as open ended may or may not further include additional elements in addition to the required elements. The term “consist of” is a closed ended expression. However, even configurations that are expressed by closed ended terms can include normally-associated impurities and additional elements that are irrelevant to the pertinent technology. The term “substantially consist of” is a semi-closed ended expression. Configurations that are expressed by semi-closed ended terms allow addition of elements that do not substantially affect the basic and novel characteristics of the pertinent technology.

Geometric terms are not to be construed in a strict sense. Examples of such geometric terms include “parallel”, “perpendicular”, “orthogonal”, and so forth. For example, directions, angles, distances, and the like may be relatively displaced within a range in which substantially the same or similar functions are obtained. The geometric terms can include tolerances, errors, and the like regarding, for example, designing, working, manufacturing, and so forth. There are cases in which dimensional relations in each drawing do not match actual dimensional relations. There are cases in which the dimensional relations of the drawings are changed to facilitate understanding by the reader. There are cases in which the length, width, thickness, and so forth, are changed. There are cases in which parts of configurations are omitted.

Numerical values can be expressed in significant figures. Measurement values can be average values of measurements that are made a plurality of times, unless otherwise specified. The number of times of measurements may be 3 times or more, 5 times or more, or 10 times or more. Generally, the greater the number of measurements, is, the more reliability of the average value is expected to improve. Measured values can be rounded off based on the number of digits of the significant figures. Measured values can include error or the like associated with, for example, the detection limit of a measuring device.

The devices, software, and so forth, used for measurement and so forth of various types of values, are merely examples. Items that are equivalent to devices and so forth that are exemplified may also be used. When equivalent items are used, measurement conditions may be adjusted in accordance with the device.

A cross-sectional scanning electron microscope (SEM) image of a cathode active material is obtained by the following procedures. For example, 1 g of a cathode active material (powder) is dispersed in a mixture (10 g) of a base agent of an epoxy resin (product name “EPOTEX JP”, manufactured by Nissin EM Co., Ltd.) and a curing agent, to form a dispersion liquid. The dispersion liquid is stirred and mixed for 1 minute using a mixer (product name: “Awatori Rentaro”, manufactured by Thinky Corporation). The stirring speed may be, for example, about 2000 rpm. The dispersion liquid is vacuum degassed. After vacuum degassing, a cylindrical resin container is filled with the dispersion liquid. The dispersion liquid is left standing for one day, whereby the epoxy resin is cured. After curing, the cured product is subjected to wet polishing, thereby preparing a cross-sectional sample having a smooth cross-section. SEM observation of the smooth cross-section is carried out to obtain a cross-sectional SEM image of the cathode active material.

The term “single-crystal particle” refers to a solid particle that is recognized as being the smallest unit of a particle and that cannot be divided any further. Single-crystal particles do not appear to have particle boundaries in cross-section SEM images. Single-crystal particles are also referred to as “primary particles”. An aggregate of more than two or more primary particles is deemed to be a “polycrystalline particle”. In the cross-sectional SEM image, 100 particles are randomly extracted. A proportion of count of single-crystal particles is identified by counting the count of single-crystal particles that are contained in the 100 particles.

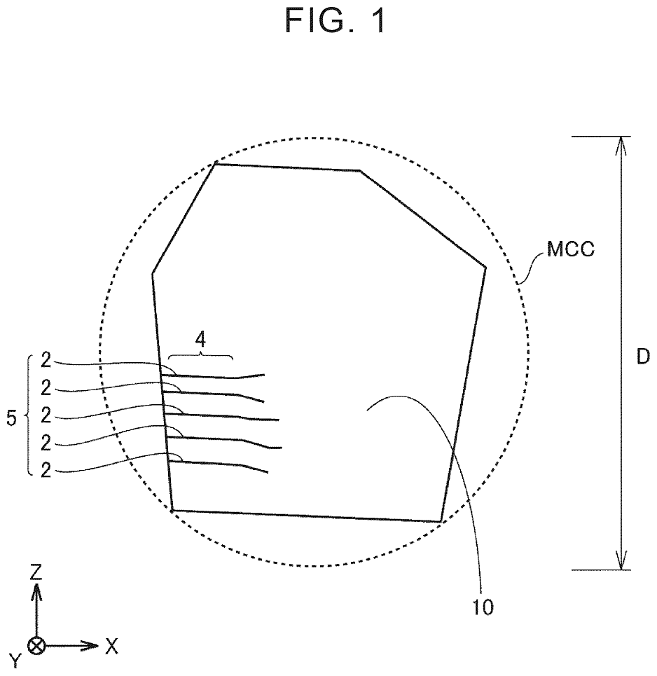

In the cross-sectional SEM image, 100 single-crystal particles are randomly extracted. From among the 100 single-crystal particles, single-crystal particles having a crack group in cross-sections thereof are further extracted. FIG. 1 is a schematic cross-sectional view of a single-crystal particle according to the present embodiment. A crack group 5 is formed in a cross-section of a single-crystal particle 10. The crack group 5 includes two or more cracks 2. The crack group 5 includes a portion at which two or more cracks 2 extend in parallel. Hereinafter, this portion will also be referred to as “parallel portion 4”. For each single-crystal particle that is extracted, the diameter of a minimum circumscribed circle (MCC) of the single-crystal particle is measured. The diameter of the MCC is deemed to be the particle diameter. Further, the crack count and the crack lengths are measured. “Crack count” refers to the number of cracks that do not intersect with other cracks. “Crack length” refers to the path length (total length) of the crack. Measurement of various dimensions, shape analysis, and so forth, in the cross-sectional SEM image, can be carried out using image analysis software such as “ImageJ” or the like, for example. For example, dimensions and the like may be measured at an image magnification of 10,000 times to 30,000 times. The average value of the particle diameter of all the single-crystal particles that are the object of being measured is deemed to be particle diameter “D”. The average value of the crack length of all single-crystal particles that are the object of being measured is deemed to be crack length “L”. The average value of the number of cracks in all single-crystal particles that are the object of being measured is deemed to be a crack count “n”. The crack length “L” is divided by the diameter “D” to calculate a proportion of crack length to particle diameter “L/D”. The proportion “L/D” is expressed as a percentage.

The chemical composition of the cathode active material can be measured by inductively coupled plasma atomic emission spectroscopy (ICP-AES). A sample solution is prepared by dissolving 0.1 g of a sample (cathode active material) in a mixed acid (10 ml) of hydrochloric acid and sulfuric acid. The sample solution is diluted to an appropriate concentration using a volumetric flask. After dilution, composition analysis is carried out using an ICP-AES device. For example, product name “PS3520UVDDII (manufactured by Hitachi High-Tech Science Corporation)”, or the like, may be used.

“D50” indicates the particle size at which cumulative frequency becomes 50% in a volume-based particle size distribution (cumulative distribution). D50 can be measured by laser diffraction, for example. Similarly to D50, the particle size at which the cumulative frequency becomes 10% is also referred to as “D10”, and the particle size at which the cumulative frequency becomes 90% is also referred to as “D90”.

### Cathode Active Material

The cathode active material is for use in a battery. The battery may be a liquid battery or an all-solid-state battery. In all-solid-state batteries as well, for example, mitigation of stress concentration is expected to lead to improved cycle characteristics. The battery may have any structure. The battery may have, for example, a wound type or laminated type power generating element. The battery may, for example, have a unipolar structure or a bipolar structure.

The cathode active material is an aggregate of particles (powder). The D50 of the powder may be, for example, 1 μm or more, 3 μm or more, 5 μm or more, 10 μm or more, or 15 μm or more. The D50 of the powder may be, for example, 30 μm or less, 20 μm or less, or 10 μm or less.

The cathode active material contains single-crystal particles. The cathode active material may further contain polycrystalline particles in addition to the single-crystal particles. The polycrystalline particles may have substantially the same crystal structure and composition as the single-crystal particles. The cathode active material may be made up of, for example, 50% or more single-crystal particles in terms of proportion of count, and the remainder of polycrystalline particles. The proportion of count of the single-crystal particles may be, for example, 60% or more, 70% or more, 80% or more, or 90% or more. The proportion of count of single-crystal particles may be, for example, 100% or less, 90% or less, or 80% or less. For example, due to the proportion of count of single-crystal particles being 50% or more, improvement in cycle characteristics can be expected.

The cathode active material may be a monodisperse system. Due to the powder being mainly made up of single-crystal particles and also being a monodisperse system, cycle characteristics can be expected to improve. The powder may, for example, have a span of 1 or less. The term “span” indicates a value that is calculated by a formula “(D90−D10)/D50”. It is thought that the smaller the span is, the sharper the particle size distribution is. The span of the powder may be, for example, 0.9 or less, 0.8 or less, 0.7 or less, 0.6 or less, or 0.5 or less. The span of the powder may be, for example, 0.1 or more, 0.2 or more, 0.3 or more, 0.4 or more, or 0.5 or more.

As illustrated in FIG. 1, the crack group 5 is formed in the cross-section of the single-crystal particle 10. It is expected that the initial resistance will be reduced by an electrolytic solution diffusing into the single-crystal particles 10 through the crack group 5. Furthermore, the crack group 5 is expected to mitigate stress concentration, thereby improving cycle characteristics as well.

A single crack group 5 may be formed in the single-crystal particle 10, or a plurality of the crack groups 5 may be formed. The number of crack groups 5 may be, for example, 2 or more, 3 or more, or 4 or more. The number of crack groups 5 may be, for example, 10 or less, 5 or less, 4 or less, 3 or less, or 2 or less.

The crack group 5 includes two or more cracks 2. The crack count may be, for example, 3 or more, 4 or more, 5 or more, 6 or more, 7 or more, 8 or more, 9 or more, or 10 or more. The crack count may be, for example, 20 or less, 15 or less, 10 or less, 9 or less, 8 or less, 7 or less, 6 or less, 5 or less, 4 or less, or 3 or less. In addition to reducing the initial resistance, improvement in cycle characteristics is also expected, by limiting the crack count to 4 or more and 8 or less, for example.

Each crack 2 has an origin thereof on a surface of the single-crystal particle 10. Each crack 2 extends from the surface of the single-crystal particle 10 toward an interior of the single-crystal particle 10. The crack 2 may extend in a straight line or extend in a curved line. For example, the crack 2 may extend in a depth direction in FIG. 1, such that there are portions where the crack 2 appears to be a dotted line.

Reduction in initial resistance is expected due to a relation of “3%≤L/D” being satisfied between the crack length “L” and the particle diameter “D”. The proportion “L/D” may be, for example, 6% or more, 12% or more, 18% or more, 24% or more, 30% or more, 31% or more, 36% or more, 42% or more, 48% or more, 52% or more, or 54% or more. The proportion “L/D” may be, for example, 60% or less, 54% or less, 52% or less, 48% or less, 42% or less, 36% or less, 31% or less, 30% or less, 24% or less, 18% or less, 12% or less, or 6% or less. For example, when the proportion “L/D” is 6% or more, reduction in the initial resistance and improvement in cycle characteristics are expected. When the proportion “L/D” becomes excessively great, there is a possibility that particle breakage may occur with a crack as an origin thereof. When the proportion “L/D” is 52% or less, improvement in cycle characteristics is expected.

The particle diameter “D” may be, for example, 0.1 μm or more, 0.5 μm or more, 1 μm or more, 2 μm or more, 3 μm or more, 4 μm or more, 5 μm or more, 6 μm or more, 7 μm or more, 8 μm or more, 9 μm or more, or 10 μm or more. The particle diameter “D” may be, for example, 15 μm or less, 10 μm or less, 9 μm or less, 8 μm or less, 7 μm or less, 6 μm or less, 5 μm or less, 4 μm or less, 3 μm or less, 2 μm or less, or 1 μm or less.

The crack group 5 includes the parallel portion 4. That is to say, the crack group 5 is made up of a plurality of the cracks 2 forming the parallel portion 4. In the parallel portion 4, two or more cracks 2 do not intersect. Two or more cracks 2 extend in parallel. When an angle that is formed between directions of advance of two or more cracks 2 with a particle surface side as the origin is 10° or less, that portion is deemed to be the parallel portion 4. In the parallel portion 4, the angle that is formed between two or more cracks 2 may be, for example, 5° or less, 3° or less, or 1° or less. The parallel portion 4 may extend over the entire length of the cracks 2. The parallel portion 4 may be part of the overall length of the crack 2. The percentage of the length of the parallel portion 4 as to the crack length “L” may be, for example, greater than 0%, 5% or more, 10% or more, 20% or more, 30% or more, 40% or more, 50% or more, 60% or more, 70% or more, 80% or more, or 90% or more. The percentage of the length of the parallel portion 4 as to the crack length “L” may be, for example, 100% or less, 90% or less, 80% or less, 70% or less, 60% or less, 50% or less, 40% or less, 30% or less, 20% or less, 10% or less, or 5% or less.

“Width of the crack 2” refers to a dimension in a direction that is perpendicular to a length direction. The width of the crack 2 may be, for example, one hundredth of the crack length “L” or less, or one tenth thereof or less. The width of the crack 2 may be, for example, less than 10 nm. The width of the crack 2 may be, for example, 9 nm or less, 8 nm or less, 7 nm or less, 6 nm or less, 5 nm or less, 4 nm or less, 3 nm or less, 2 nm or less, or 1 nm or less. The width of the crack 2 may be, for example, 0.1 nm or more, 1 nm or more, 2 nm or more, 3 nm or more, 4 nm or more, 5 nm or more, 6 nm or more, 7 nm or more, 8 nm or more, or 9 nm or more.

Intervals between the cracks 2 in a width direction may be constant or may be indeterminate. The intervals between the cracks 2 may be, for example, one-half the crack length “L” or less, one-third thereof or less, one-quarter thereof or less, or one-fifth thereof or less. The intervals between the cracks 2 may be, for example, one hundredth of the crack length “L” or more, or one tenth thereof or more.

The cathode active material may include, for example, a lithium transition metal composite oxide. The cathode active material may have a crystal structure belonging to space group R-3m. This crystal structure is also referred to as “layered structure”. The crystal structure can be identified by an X-Ray Diffraction (XRD) pattern. The lithium transition metal composite oxide contains Li, a transition metal, and oxygen.

The cathode active material may have a composition that is represented by the general formula “LiₓNiₐCo_{b}Mn_{c}O_{y}”, for example. In the general formula, the Li composition ratio “x” may satisfy a relation of, for example, “0.1≤x≤1.5”. The Li composition ratio “x” may be, for example, 0.4 or more, 0.6 or more, 0.8 or more, 1.0 or more, 1.2 or more, or 1.4 or more. The Li composition ratio “x” may be, for example, 1.4 or less, or 1.2 or less.

In the above general formula, the O composition ratio “y” may satisfy a relation of, for example, “1.5≤y≤2.1”. The O composition ratio “y” may be, for example, 1.6 or more, 1.7 or more, 1.8 or more, 1.9 or more, or 2.0 or more. The O composition ratio “y” may be, for example, 2.0 or less, 1.9 or less, 1.8 or less, 1.7 or less, or 1.6 or less.

In the above general formula, the Ni composition ratio “a”, the Co composition ratio “b” and the Mn composition ratio “c” may satisfy a relation of “a+b+c=1.0”. The Ni composition ratio “a” may satisfy a relation of “0.5≤a≤1.0”, for example. The Ni composition ratio “a” may be, for example, 0.6 or more, 0.7 or more, 0.8 or more, or 0.9 or more. The Ni composition ratio “a” may be, for example, 0.9 or less, 0.8 or less, 0.7 or less, or 0.6 or less.

In the above general formula, the Co composition ratio “b” may satisfy a relation of, for example, “0≤b≤0.3”. The Co composition ratio “b” may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Co composition ratio “b” may be, for example, 0.25 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

In the above general formula, the Mn composition ratio “c” may satisfy a relation of, for example, “0≤c≤0.3”. The Mn composition ratio “c” may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Mn composition ratio “c” may be, for example, 0.25 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

Note that in the above general formula, all or part of Mn may be substituted with Al or the like. That is to say, the lithium transition metal composite oxide may have a composition that is represented by the general formula “LiₓNiₐCo_{b}Al_{c}O_{y}”, for example. The range of the Al composition ratio “c” is the same as that of the Mn composition ratio “c” described above.

An optional dopant may be added to the lithium transition metal composite oxide. The term “dopant” refers to an element other than Li, Ni, Co, Mn, and O. The dopant may include, for example, at least one selected from a group consisting of Zr, Mo, W, Mg, Ca, Na, Fe, Cr, Zn, Si, Sn, Al, and Ag. The composition ratio of the dopant may be, for example, 0.005 or more, 0.01 or more, 0.02 or more, 0.03 or more, or 0.04 or more. The composition ratio of the dopant may be, for example, 0.05 or less, 0.04 or less, 0.03 or less, 0.02 or less, or 0.01 or less.

### Sample Fabrication

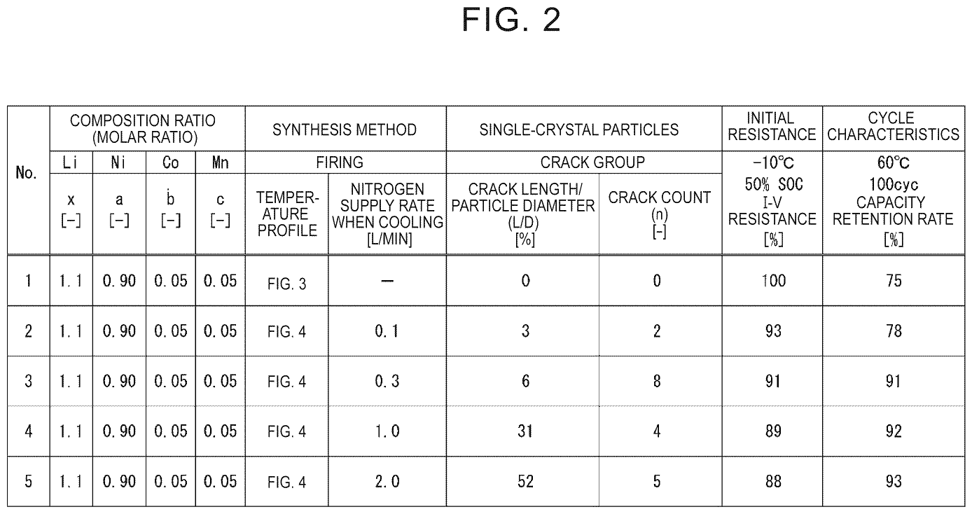

FIG. 2 is a table showing results of experimentation. Cathode active materials No. 1 to No. 5 were produced by the following procedures.

### Precursor Preparation

NiSO₄, CoSO₄, and MnSO₄ are dissolved in ion-exchanged water to form a raw material solution. In the raw material solution, the molar ratio of Ni, Co and Mn is “Ni/Co/Mn=90/5/5”. The solute concentration in the raw material solution is 30% (mass fraction).

Aqueous ammonia is placed in a reaction vessel. Gasses inside the reaction vessel are replaced with nitrogen gas, while stirring the aqueous ammonia with a stirrer. Furthermore, NaOH is added to the reaction vessel to form an alkaline reaction liquid.

The raw material solution and aqueous ammonia are added dropwise to the reaction solution so as to maintain the pH of the reaction liquid within a certain range, thereby forming a precipitate (metal hydroxide). The reaction liquid is filtered to recover the metal hydroxide. The metal hydroxide is dispersed in ion-exchanged water to form a dispersion liquid. The dispersion liquid is thoroughly stirred with a spatula. That is to say, the metal hydroxide is washed with water. The dispersion liquid is filtered after washing with water, to recover the metal hydroxide. The metal hydroxide is dried at 120° C. for 16 hours to form a dried product.

### Addition of Li Source

In a mortar, the dry products (metal hydroxide) and lithium compounds (LiOH, Li₂CO₃) are mixed with a pestle to form a mixture. By charging an excess amount of Li relative to the total amount of substance of the transition metals, a molten salt is formed during firing, and monocrystalization of the lithium transition metal composite oxide can be performed. That is to say, the proportion of count of single-crystal particles can be 50% or more. The proportion of the amount of substance of Li as to the total amount of substance of the transition metals is, for example, 1.5 or more.

### Firing

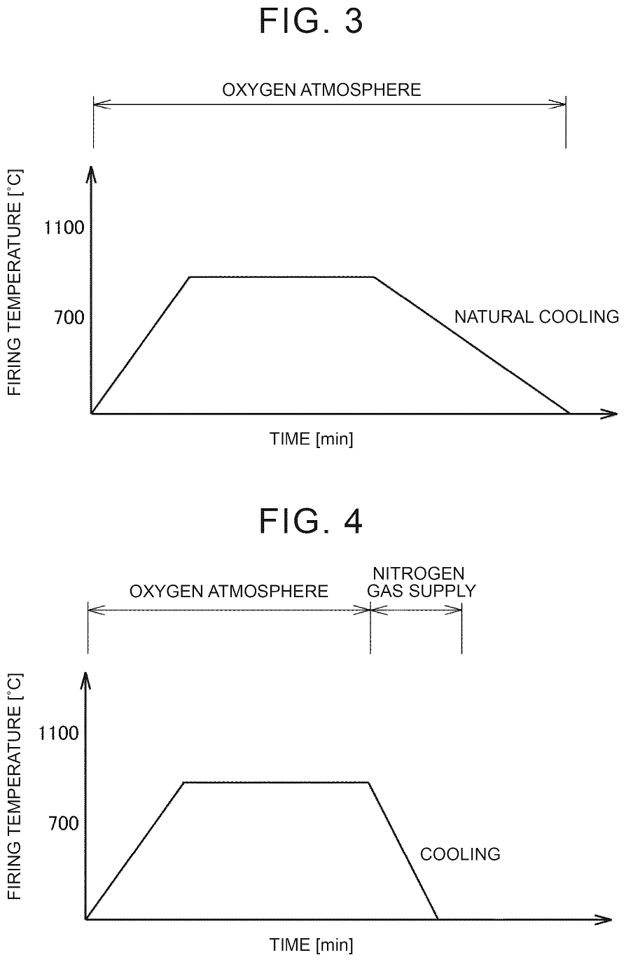

The mixture is fired (thermally treated) in a firing furnace (e.g., muffle furnace) to synthesize a lithium transition metal composite oxide. The firing atmosphere is an oxygen atmosphere. FIG. 3 is a first temperature profile. In No. 1, firing is carried out according to the first temperature profile. The temperature in the furnace is raised to a firing temperature in a range of 700° C. to 1100° C. The firing temperature is substantially maintained for 10 hours. After 10 hours have elapsed, the temperature inside the furnace is naturally cooled down to room temperature.

FIG. 4 is a second temperature profile. In No. 2 to No. 5, firing is carried out according to the second temperature profile. The temperature in the furnace is raised to the firing temperature in the range of 700° C. to 1100° C. The firing temperature is substantially maintained for 10 hours. After 10 hours, nitrogen gas is supplied into the furnace, thereby cooling inside of the furnace. The nitrogen gas supply rate for each sample is shown in the item “Nitrogen supply rate during temperature drop” in FIG. 2.

After the firing, the particle size of the lithium transition metal composite oxide is adjusted by a pulverizer such as a jet mill or the like. Thus, the cathode active material is produced.

### Measurement of Initial Resistance

The initial resistance was measured by the following procedures. A laminate cell is fabricated. The laminate cell has the following configuration.
Exterior: Pouch made of aluminum laminated film
Power generation element: laminated type (single layer)
Cathode: cathode active material/conductive material/binder=88/10/2 (mass ratio)
Anode: Anode active material (natural graphite), CMC, SBR
Electrolyte: LiPF₆ (1 mol/L), EC/DMC/EMC=3/4/3 (volumetric ratio)

The cathode and the anode are each produced by applying a slurry to a surface of a substrate (metal foil). As the coating device, a film applicator (with film thickness adjustment function), manufactured by Allgood Co., Ltd., for example, is used. After applying the slurry, the coating is dried at 80° C. for 5 minutes.

The laminate cell is sandwiched between two stainless steel plates, thereby applying a predetermined pressure to the power generating element. The state of charge (SOC) of the laminated cell is adjusted to 50%. I-V resistance is measured in a temperature environment of −10° C. The values shown in the “initial resistance” column in FIG. 2 are relative values in which the value of initial resistance of No. 1 is 100%.

### Measurement of Cycle Characteristics

Cycle tests are carried out on the laminate cell under the following conditions.
Ambient temperature: 60° C.
Number of cycles: 100
Current rate: 0.3 C
Voltage range: 4.25V to 2.5V

At a current rate of 1 C, the rated capacity of the cell is drained in 1 hour. 0.3 C is 0.3 times 1 C. At the 1st cycle, 25th cycle, 50th cycle, 75th cycle and 100th cycle, the discharge capacity is measured at a current rate of 0.2 C. The capacity retention rate is calculated by dividing the discharge capacity at the 100th cycle by the discharge capacity at the first cycle. It is thought that the higher the capacity retention rate is, the better the cycle characteristics will be.

### Experiment Results

As shown in FIG. 2, when the relation of “3%≤L/D” is satisfied, there is a tendency for the initial resistance to decrease.

When the crack count is 4 or more and 8 or less, the initial resistance is reduced and also the cycle characteristics tend to improve.

When the relation of “6%≤L/D≤52%” is satisfied, the initial resistance is reduced and also the cycle characteristics tend to improve.

What is claimed is:

1. A cathode active material for a lithium-ion secondary battery, the cathode active material containing a single-crystal particle, wherein
a crack group is created in a cross-section of the single-crystal particle,
the crack group includes two or more cracks,
the crack group includes a portion in which two or more of the cracks extend in parallel, and
a relation of 3%≤L/D is satisfied, in which
the L indicates a length of the cracks, and also
the D indicates a diameter of a smallest circumscribing circle of the single-crystal particle in the cross-section.

2. The cathode active material according to claim 1, wherein the crack group includes four or more to eight or less of the cracks.

3. The cathode active material according to claim 1, wherein a relation of 6%≤L/D≤52% is satisfied.

4. The cathode active material according to claim 1, wherein the cathode active material is made up of the single-crystal particles that account for 50% or more in proportion of count, and polycrystalline particles that are a remainder.

5. The cathode active material according to claim 1, wherein
a composition of the cathode active material is expressed by a general formula: LiₓNiₐCo_{b}Mn_{c}O_{y}, and
in the general formula, x, a, b, c, and y satisfy relations of 0.1≤x≤1.5, 0.5≤a≤1.0, 0≤b≤0.3, 0≤c≤0.3, a+b+c=1.0, and 1.5≤y≤2.1.
